(19) United States
(12) Patent Application Publication
(10) Pub. No.: US 2022/0414453 A1
(43) Pub. Date: Dec. 29, 2022

(54) DATA AUGMENTATION USING BRAIN EMULATION NEURAL NETWORKS

(71) Applicant: X Development LLC, Mountain View, CA (US)

(72) Inventors: Bangyan Chu, Fairfax, VA (US); Sarah Ann Laszlo, Mountain View, CA (US)

(21) Appl. No.: 17/360,680

(22) Filed: Jun. 28, 2021

(51) Int. Cl. G06N 3/08; G06N 3/06; G06K 9/62; G06T 5/00

(52) U.S. Cl. CPC G06N 3/08; G06N 3/061; G06K 9/6201; G06K 9/623; G06K 9/6261; G06K 9/6296; G06T 5/002; G06T 2207/20084; G06T 2207/20081

(57) ABSTRACT

In one aspect, there is provided a method performed by one or more data processing apparatus, the method including receiving a training dataset having multiple training examples, where each training example includes: (i) an image, and (ii) a segmentation defining a target region of the image that has been classified as including pixels in a target category. The method further includes determining a respective refined segmentation for each training example, including, for each training example, processing the target region of the image defined by the segmentation for the training example using a de-noising neural network to generate a network output that defines the refined segmentation for the training example. The method further includes training a segmentation machine learning model on the training examples of the training dataset, including, for each training example training the segmentation machine learning model to process the image included in the training example to generate a model output that matches the refined segmentation for the training example.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes a system implemented as computer programs on one or more computers in one or more locations for training a segmentation machine learning model that is configured to process an image to generate a segmentation of a target category of pixel in the image. The segmentation of the target category of pixel in the image defines, for each pixel in the image, whether the pixel is included in the target category. For example, the segmentation machine learning model can be configured to process satellite images to generate a segmentation of the electrical power transmission lines in the satellite image.

The system can receive a training dataset for training the segmentation machine learning model that includes a set of training examples, where each training example specifies: (i) an image, and (ii) a segmentation of the image. The segmentation of the image defines a target region of the image, e.g., specified by a bounding box enclosing a region of the image, that has been classified, e.g., by manual human annotation, as including pixels in the target category.

Generally, for each training example, the segmentation includes at least some pixels that are not included in the target category. For example, if the images are satellite images and the target category is pixels that are included in electrical power transmission lines, then the segmentation of each satellite image can define a bounding box in the satellite image. The bounding box in each satellite image can include both: (i) electrical power transmission lines, and (ii) background vegetation and structures in proximity to the electrical power transmission lines. Generating a more precise pixel-wise segmentation of the target pixels of interest by manual annotation can be prohibitively difficult and time-consuming.

However, within the target region of an image that is specified by a segmentation, the pixels included in the target category may have a predictable intensity and spatial distribution throughout the target region. In contrast, the remaining pixels in the target region that are not included in the target category may have apparently random intensity and spatial distribution characteristics. For example, within a bounding box in a satellite image, electrical power transmission lines (i.e., the target category in this example) have a predictable spatial distribution in the bounding box as long straight lines, while the background vegetation does not share this spatial distribution.

The system can exploit the predictable distribution of the pixels in the target category in a target region to generate refined segmentations that provide a precise pixel-wise delineation of the target category of pixels in an image. More specifically, the system can first train a “de-noising” neural network to perform a de-noising task, i.e., by processing a noisy version of an image to generate an estimate of the original image (i.e., without the noise). Then, for each image in the training dataset for the segmentation machine learning model, the system processes the target region of the image using the de-noising neural network to generate a de-noised representation of the target region of the image. The de-noised representation of the target region of the image can define an approximate pixel-wise segmentation of the target category of pixels in the target region that provide a refined segmentation of the target category of pixels.

After generating a respective refined segmentation for each image in the training dataset, the system trains the segmentation machine learning model to process the images in the training dataset to generate outputs that match the refined segmentations. Training the segmentation neural network (e.g., the segmentation machine learning model) using the refined segmentations enables the segmentation neural network to segment the target category of pixels more accurately, e.g., by generating a pixel-wise segmentation of the target pixels, rather than only a bounding box that encloses the target pixels along with other irrelevant pixels.

In some implementations, the de-noising neural network includes a “brain emulation” sub-network having an architecture that is based on synaptic connectivity between biological neurons in a brain of a biological organism, as will be described in more detail below.

Throughout this specification, a “neural network” refers to an artificial neural network, i.e., that is implemented by one or more computers. For convenience, a neural network having an architecture derived from a synaptic connectivity graph representing synaptic connectivity in a biological brain may be referred to as a “brain emulation” neural network. Identifying an artificial neural network as a “brain emulation” neural network is intended only to conveniently distinguish such neural networks from other neural networks (e.g., with hand-engineered architectures), and should not be interpreted as limiting the nature of the operations that may be performed by the neural network or otherwise implicitly characterizing the neural network.

Throughout this specification, a “satellite” refers to a device placed into orbit, e.g., around the Earth. A satellite may be equipped with a camera that enables the satellite to capture images, e.g., of the Earth, that are referred to herein as “satellite images”. The techniques described in this specification can be used for processing satellite images, but are not restricted to satellite images and can be used to process any of a variety of types of images. For example, the techniques described herein can be used to process aerial images more generally, e.g., images that are captured from aircraft, drones, or other flying objects, or images captured by a telescope. In another example, the techniques described herein can be used to process medical images such as, e.g., images of the cardiovascular system.

Throughout this specification, an “image” can refer to any appropriate type of image, e.g., a color image (e.g., an RGB image represented by a red channel, a green channel, and a blue channel), a hyperspectral image, or a density image (e.g., as generated by a computed tomography (CT) scanner). An image can be, e.g., a two-dimensional (2D) image, a three-dimensional (3D) image, or more generally, an N-dimensional (N-D) image.

An image can be represented, e.g., as an array of “pixels,” where each pixel is associated with a respective spatial location in the image and corresponds to a respective vector of one or more numerical values representing image data at the spatial location. For example, a 2D RGB image can be represented by a 2D array of pixels, where each pixel is associated with a respective 3D vector of values representing the intensity of red, green, and blue color at the spatial location corresponding to the pixel in the image.

According to a first aspect, there is provided a method performed by one or more data processing apparatus, the method including receiving a training dataset having multiple training examples, where each training example includes: (i) an image, and (ii) a segmentation defining a target region of the image that has been classified as including pixels in a target category. The method further includes determining a respective refined segmentation for each training example, including, for each training example, processing the target region of the image defined by the segmentation for the training example using a de-noising neural network to generate a network output that defines the refined segmentation for the training example, where the de-noising neural network includes a brain emulation sub-network having a brain emulation neural network architecture that is based on synaptic connectivity between biological neurons in a brain of a biological organism. The method further includes training a segmentation machine learning model on the training examples of the training dataset, including, for each training example, training the segmentation machine learning model to process the image included in the training example to generate a model output that matches the refined segmentation for the training example.

In some implementations, for each of the multiple training examples, the segmentation included in the training example specifies a bounding box that encloses the target region of the image of the training example.

In some implementations, for each of the multiple training examples, the refined segmentation for the training example defines a refined target region of the image that is a proper subset of the target region of the image of the training example.

In some implementations, for each of the multiple training examples, the refined target region of the image has an area that is less than 10% of an area of the target region of the image.

In some implementations, for each of the multiple training examples, the image included in the training example is a satellite image, the segmentation included in the training example specifies a bounding box in the image that encloses electrical power transmission lines, and the refined segmentation for the training example specifies a collection of pixels in the bounding box that are predicted to be included in the electrical transmission lines.

In some implementations, the de-noising neural network has been trained to perform a de-noising task, including obtaining multiple de-noising training examples, where each de-noising training example includes: (i) an original image, and (ii) a noisy image that is generated by combining noise with the original image, and training the de-noising neural network on the multiple de-noising training examples, including, for each de-noising training example, training the de-noising neural network to process the noisy image from the de-noising training example to generate an output that matches the original image from the de-noising training example.

In some implementations, for each de-noising training example, training the de-noising neural network to process the noisy image from the de-noising training example to generate an output that matches the original image from the de-noising training example includes processing the noisy image using the de-noising neural network to generate a predicted image, and determining an update to values of a plurality of de-noising neural network parameters based on an error between: (i) the predicted image, and (ii) the original image.

In some implementations, for each of the multiple de-noising training examples, the noisy image included in the de-noising training example is generated by adding Gaussian noise to the original image included in the de-noising training example.

In some implementations, for each of the multiple de-noising training examples, the original image included in the training example is a synthetic image.

In some implementations, for each of the multiple training examples, the segmentation is generated by manual annotation.

In some implementations, the brain emulation neural network architecture is determined from a synaptic connectivity graph that represents the synaptic connectivity between the biological neurons in the brain of the biological organism.

In some implementations, the synaptic connectivity graph includes multiple nodes and edges, each edge connects a pair of nodes, each node corresponds to a respective neuron or group of neurons in the brain of the biological organism, and each edge connecting a pair of nodes in the synaptic connectivity graph corresponds to a synaptic connection between a pair of biological neurons or groups of biological neurons in the brain of the biological organism.

In some implementations, the synaptic connectivity graph is generated by multiple operations including obtaining a synaptic resolution image of at least a portion of the brain of the biological organism, and processing the image to identify: (i) multiple neurons in the brain, and (ii) multiple synaptic connections between pairs of neurons in the brain.

In some implementations, determining the brain emulation neural network architecture from the synaptic connectivity graph includes mapping each node in the synaptic connectivity graph to a corresponding artificial neuron in the brain emulation neural network architecture; and mapping each edge in the synaptic connectivity graph to a connection between a corresponding pair of artificial neurons in the brain emulation neural network architecture.

In some implementations, determining the brain emulation neural network architecture from the synaptic connectivity graph further includes instantiating a respective parameter value associated with each connection between a pair of artificial neurons in the brain emulation neural network architecture that is based on a respective proximity between a corresponding pair of biological neurons or groups of biological neurons in the brain of the biological organism.

In some implementations, determining the brain emulation neural network architecture from the synaptic connectivity graph includes generating data defining multiple candidate graphs based on the synaptic connectivity graph, determining, for each candidate graph, a performance measure on a segmentation task of an instance of a segmentation neural network having a sub-network with an architecture that is specified by the candidate graph, and selecting the brain emulation neural network architecture based on the performance measures.

In some implementations, each of the multiple candidate graphs is a respective sub-graph of the synaptic connectivity graph.

In some implementations, selecting the brain emulation neural network architectures based on the performance measures includes identifying a best-performing candidate graph that is associated with a highest performance measure from among the multiple candidate graphs, and selecting the brain emulation neural network architecture to be an artificial neural network architecture specified by the best-performing candidate graph.

According to a second aspect, there are provided a system including: one or more computers, and one or more storage devices communicatively coupled to the one or more computers, where the one or more storage devices store instructions that, when executed by the one or more computers, cause the one or more computers to perform the operations of the method of any preceding aspect.

According to a third aspect, there are provided one or more non-transitory computer storage media storing instructions that, when executed by one or more computers, cause the one or more computers to perform the operations of the method of any preceding aspect.

Particular embodiments of the subject matter described in this specification can be implemented so as to realize one or more of the following advantages.

The de-noising neural network described in this specification can process an image to generate a prediction characterizing the image, e.g., a pixel-wise segmentation of the image that identifies which pixels of the image are included in a particular category, e.g., power lines. The de-noising neural network can include a brain emulation sub-network that is derived from a synaptic connectivity graph representing synaptic connectivity in the brain of a biological organism. The brain of the biological organism may be adapted by evolutionary pressures to be effective at solving certain tasks. For example, in contrast to many conventional computer vision techniques, a biological brain may process visual (image) data to generate a robust representation of the visual data that may be insensitive to factors such as the orientation and size of elements (e.g., objects) characterized by the visual data. The brain emulation sub-network may inherit the capacity of the biological brain to effectively solve tasks (in particular, de-noising tasks) and thereby enable the de-noising neural network to perform de-noising tasks more effectively, e.g., with higher accuracy.

The de-noising neural network can generate pixel-level segmentations of images, i.e., that can identify each pixel of the image as being included in a respective category. In contrast, a person may manually label the positions of entities (e.g., power lines) in an image, e.g., by drawing a bounding box around the entity. The dataset having the more precise, pixel-level segmentations generated by the de-noising neural network can be used to train other segmentation machine learning models to generate a model output that matches the segmentation generated by the de-noising neural network, thereby harnessing the capacity of the brain emulation neural network to effectively perform de-noising tasks. After training, the segmentation machine learning model may be able to process any type of image to generate precise, pixel-level segmentations.

The brain emulation sub-network of the de-noising neural network may have a very large number of parameters and a highly recurrent architecture, i.e., as a result of being derived from a synaptic connectivity graph representing synaptic connectivity in the brain of a biological organism. Therefore, training the brain emulation sub-network using machine learning techniques may be computationally-intensive and prone to failure. Rather than training the brain emulation sub-network, the parameter values of the brain emulation sub-network can be determined based on the predicted strength of connections between corresponding neurons in the biological brain. Refraining from training the brain emulation sub-network of the de-noising neural network can reduce consumption of computational resources, e.g., memory and computing power, during training of the de-noising neural network.

After generating a refined segmentation for each image in a training dataset, the systems described in this specification can train the segmentation machine learning model to process the images in the training dataset to generate outputs that match the refined segmentations. Training the segmentation machine learning model on the refined segmentations (as opposed to, e.g., the original segmentations) can facilitate training the segmentation machine learning model over fewer training iterations and using less training data. In particular, the refined segmentations provide a more accurate delineation of the target category of pixels, thus reducing the occurrence of incorrectly labeled pixels in the training data. Reducing the occurrence of incorrectly labeled pixels in the training data improves the quality of the training data and enables the segmentation machine learning model to be trained to achieve an acceptable prediction accuracy over fewer training iterations and using less training data.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example data flow for generating a brain emulation neural network for inclusion in an image processing system.

FIG. 2 is a block diagram of an example image processing system.

FIG. 3 illustrates a training example and a refined segmentation generated by an image processing system.

FIG. 4 is a flow diagram of an example process for training a segmentation machine learning model to generate a model output that matches a refined segmentation.

FIG. 5 is a block diagram of an example architecture selection system.

FIG. 6A illustrates a de-noising training example.

FIG. 6B illustrates a de-noising training example.

FIG. 7 is an example data flow for generating a synaptic connectivity graph based on the brain of a biological organism.

FIG. 8 is a block diagram of an example computer system.

Like reference numbers and designations in the various drawings indicate like elements.

### DETAILED DESCRIPTION

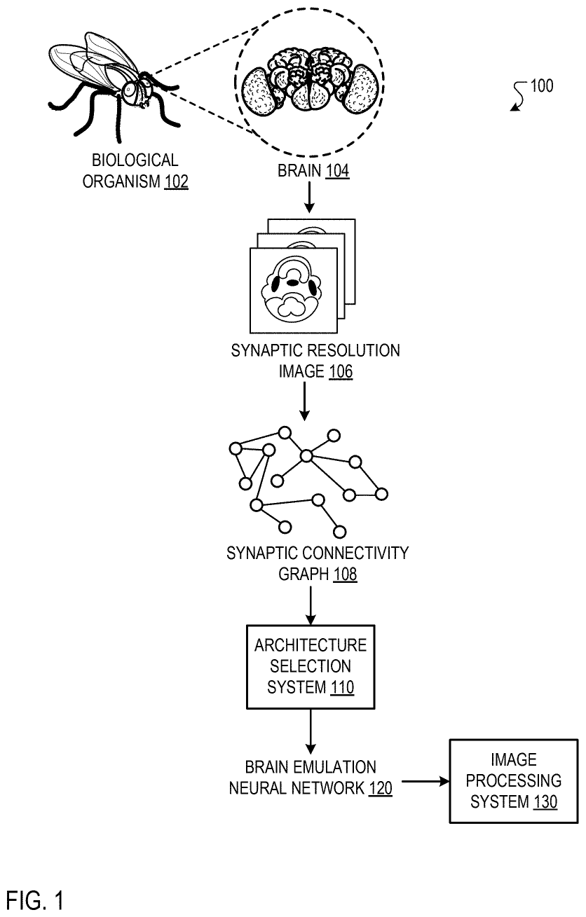

FIG. 1 illustrates an example process 100 for selecting a region of the brain 104 of a biological organism 102 for inclusion in an image processing system 130. As used throughout this document, the brain 104 can refer to any amount of nervous tissue from a nervous system of the biological organism 102, and nervous tissue can refer to any tissue that includes neurons (i.e., nerve cells). The biological organism 102 can be, e.g., a fly, a worm, a cat, or a mouse.

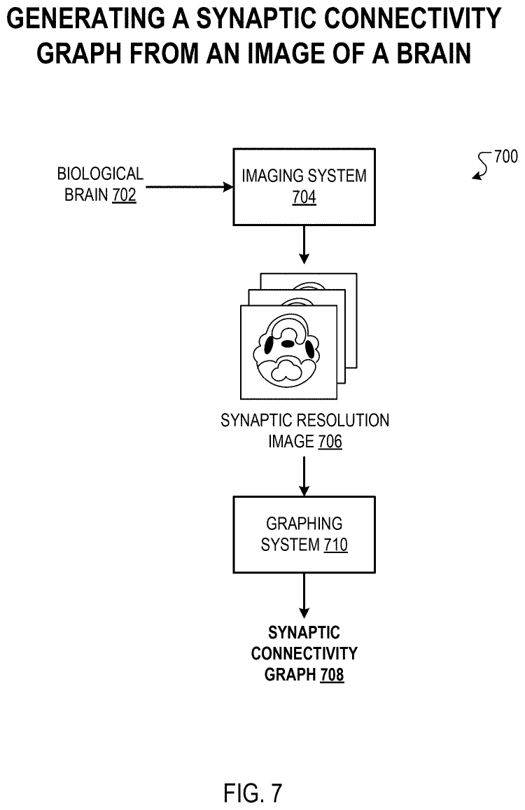

A synaptic resolution image 106 of the brain 104 can be processed to generate a synaptic connectivity graph 108 that represents synaptic connectivity between neurons in the brain 104 of the biological organism 102. For example, each node in the graph 108 can correspond to a neuron in the brain 104, and two nodes in the graph 108 can be connected if the corresponding neurons in the brain 104 share a synaptic connection. The process of generating the synaptic connectivity graph 108 from a synaptic resolution image of the brain 104 will be described in more detail below with reference to FIG. 7.

Generally, nervous tissue in a region of the brain 104 of the biological organism 102 can be adapted by evolutionary pressures to perform a particular function. For example, the nervous tissue in the visual cortex region of the brain 104 can be particularly effective at, or suitable for, processing visual data. Based on the synaptic connectivity graph 108, the architecture selection system 110 can identify a region of the brain 102 that is effective at performing a particular function and generate a brain emulation neural network 120 having an architecture that is specified by synaptic connectivity in that brain region.

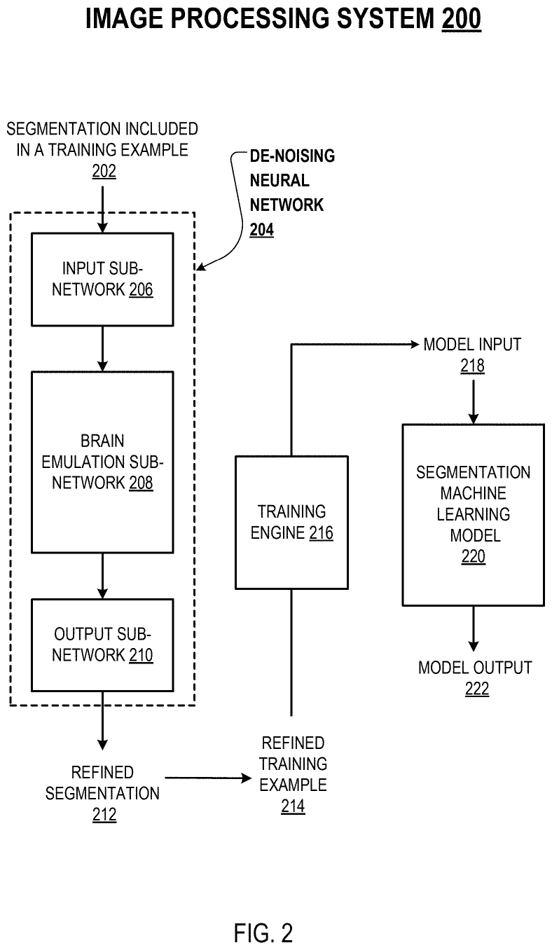

As will be described in more detail below with reference to FIG. 2, the image processing system 130 can include a de-noising neural network (e.g., implemented as a reservoir computing neural network) with the brain emulation neural network 120 acting as the reservoir. Because the architecture of the brain emulation neural network 120 is selected by the architecture selection system 110 as being suitable for, or effective at, performing a de-noising task, the de-noising neural network, incorporating the brain emulation neural network 120, can share this capacity to effectively perform the task.

Furthermore, the capacity of the brain emulation neural network 120 to be effective at the de-noising task can be harnessed by other segmentation machine learning models. For example, as will be described in more detail below with reference to FIG. 2, the de-noising neural network can be used to generate a refined (e.g., augmented) training dataset that can, in turn, be used to train a segmentation machine learning model to process an input and generate an output that matches the output generated by the de-noising neural network. In other words, by using the refined dataset generated by the brain emulation neural network 120, the segmentation machine learning model can be trained to potentially be as effective as the brain emulation neural network 120 at producing the de-noised segmentations. An example image processing system 130 that includes the brain emulation neural network 120 will be described in more detail next.

FIG. 2 is a block diagram of an example image processing system 200 (e.g., the image processing system 130 in FIG. 1). The image processing system 200 is an example of a system implemented as computer programs on one or more computers in one or more locations in which the systems, components, and techniques described below are implemented.

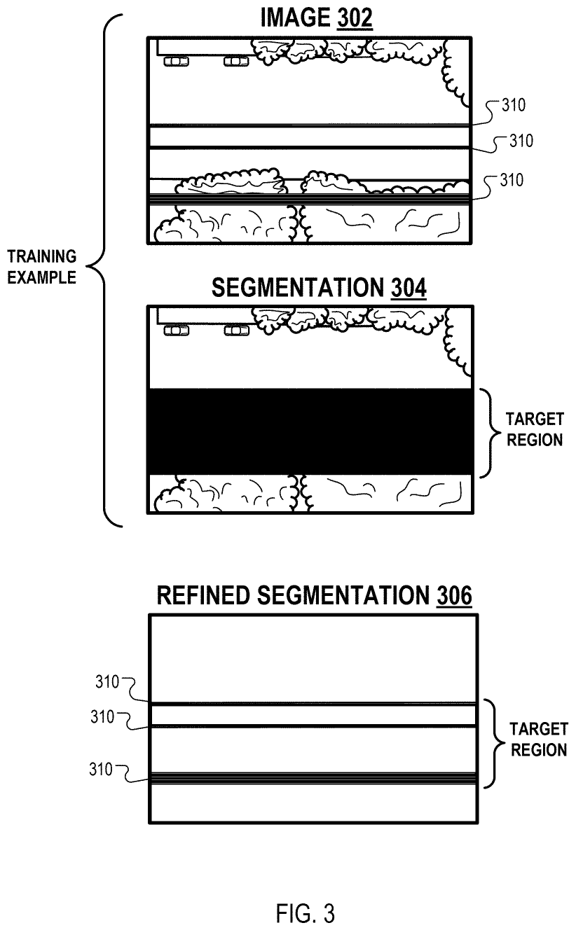

As will be described in more detail below with reference to FIG. 3, a training example dataset can include multiple training examples, and each training example can include an image and a segmentation defining a target region of the image that has been classified as including pixels in a target category, e.g., by manual human annotation. The system 200 is configured to process the target region of the image defined by the segmentation included in the training example 202 using a de-noising neural network 204 to generate a network output that defines a refined segmentation 212 for the training example (e.g., a de-noised representation of the target region of the image). The image and the refined segmentation 212 (e.g., collectively referred to as a refined training example 214) can be used to train a segmentation machine learning model 220 (e.g., a segmentation neural network) to generate a model output 22 that matches the refined segmentation 212 generated by the de-noising neural network 204.

The segmentation included in the training example 202 can specify a bounding box that encloses the target region of the image and includes pixels in a target category. For example, if the image is a satellite image, the bounding box can have pixels included in the category of power transmission lines. The set of possible target categories can be one or more of: a “power transmission line” category, a “railroad” category, a “building” category, a “roadway” category, a “driveway” category, and any other appropriate category. Generally, the segmentation included in the training example 202 can also include at least some pixels that are not in the target category, e.g., the bounding box in the satellite image can include both: (i) electrical power transmission lines, and (ii) background vegetation and structures in proximity to the electrical power transmission lines. However, within the target region of the image that is specified by the segmentation, the pixels included in the target category may have a predictable intensity and spatial distribution throughout the target region. In contrast, the remaining pixels in the target region that are not included in the target category may have apparently random intensity and spatial distribution characteristics. For example, within the bounding box in the satellite image, electrical power transmission lines (i.e., the target category in this example) have a predictable spatial distribution in the bounding box as long straight lines, while the background vegetation does not share this spatial distribution.

The system 200 can exploit the predictable distribution of the pixels in the target category in the target region to generate a refined segmentation 212 that provides a precise pixel-wise delineation of the target category of pixels in the target region in the image. Specifically, the de-noising neural network 204 can process the segmentation included in the training example 202 (e.g., the target region of the image) to generate a refined segmentation 212 for the training example, e.g., a de-noised representation of the target region of the image. The refined segmentation 212 can include, e.g., an area that is less than 10% of an area of the target region of the image.

The de-noising neural network 204 can include: (i) an input sub-network 206, (ii) a brain emulation sub-network 208, and (iii) an output sub-network 210, each of which will be described in more detail next. Throughout this specification, a “sub-network” refers to a neural network that is included as part of another, larger neural network.

The input sub-network 206 is configured to process the target region of the image defined by the segmentation for the training example 202. More specifically, the input sub-network 206 can be configured to process the target region to generate an embedding of the target region, i.e., a representation of the target region as an ordered collection of numerical values, e.g., a vector or matrix of numerical values. The input sub-network 206 can have any appropriate neural network architecture that enables it to perform its described function. For example, the input sub-network can include any appropriate types of neural network layers (e.g., fully-connected layers, convolutional layers, attention layers, etc.) in any appropriate numbers (e.g., 1 layer, 5 layers, or 10 layers) and connected in any appropriate configuration (e.g., as a linear sequence of layers).

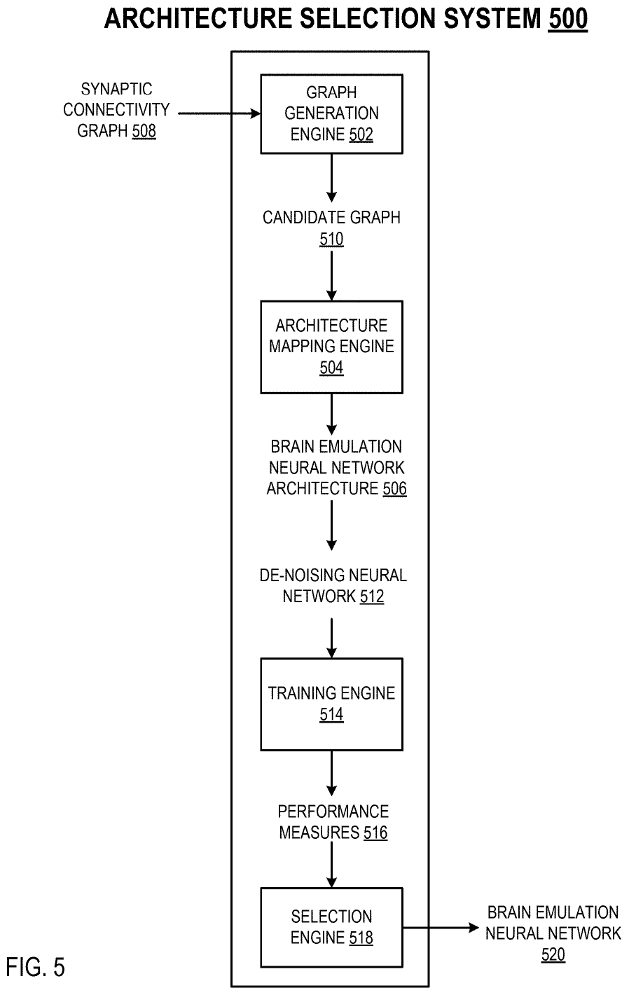

The brain emulation sub-network 208 can be configured to process the embedding of the target region of the image (i.e., that is generated by the input sub-network 206) to generate an alternative representation of the target region, e.g., as an ordered collection of numerical values, e.g., a vector or matrix of numerical values. The architecture of the brain emulation sub-network 208 is derived from a synaptic connectivity graph representing synaptic connectivity in the brain of a biological organism. The brain emulation sub-network 208 can be generated, e.g., by an architecture selection system, which will be described in more detail with reference to FIG. 5.

The output sub-network 210 is configured to process the alternative representation of the target region of the image (i.e., that is generated by the brain emulation sub-network 208) to generate the refined segmentation 212 for the training example, e.g., a de-noised representation of the target region of the image that can define an approximate pixel-wise segmentation of the target category of pixels in the target region. The output sub-network 210 may have any appropriate neural network architecture that enables it to perform its described function. In particular, the output sub-network can include any appropriate types of neural network layers (e.g., fully-connected layers, convolutional layers, attention layers, etc.) in any appropriate numbers (e.g., 1 layer, 5, layers, 10 layers, etc.) and connected in any appropriate configuration, e.g., as a linear sequence of layers.

The output of the input sub-network 206 can be provided as an input to the brain emulation sub-network 208 in a variety of possible ways. For example, the input sub-network 206 can include a respective connection from each artificial neuron in a final layer of the input sub-network to each of one or more artificial neurons of the brain emulation sub-network 208 that are designated as input neurons. In some cases, the final layer of the input sub-network 206 is fully-connected to the neurons of the brain emulation sub-network 208, i.e., such that the input sub-network 206 includes a respective connection from each artificial neuron in the final layer of the input sub-network 206 to each artificial neuron in the brain emulation sub-network 208.

The output of the brain emulation sub-network 208 can be provided as an input to the output sub-network 210 in a variety of possible ways. For example, the output sub-network 210 can include a respective connection from each artificial neuron in the brain emulation sub-network 208 that is designated as an output neuron to each of one or more artificial neurons in a first layer of the output sub-network 210. In some cases, the artificial neurons of the brain emulation sub-network 208 are fully-connected to the first layer of the output sub-network 210, i.e., such that the output sub-network 210 includes a respective connection from each artificial neuron in the brain emulation sub-network 208 to each artificial neuron in the first layer of the output sub-network 210.

In some cases, the brain emulation sub-network 208 can have a recurrent neural network architecture, i.e., where the connections in the architecture define one or more “loops.” More specifically, the architecture can include a sequence of components (e.g., artificial neurons, layers, or groups of layers) such that the architecture includes a connection from each component in the sequence to the next component, and the first and last components of the sequence are identical. In one example, two artificial neurons that are each directly connected to one another (i.e., where the first neuron provides its output to the second neuron, and the second neuron provides its output to the first neuron) would form a recurrent loop.

A recurrent brain emulation sub-network 208 can process an embedding (i.e., generated by the input sub-network 206) over multiple (internal) time steps to generate a respective alternative representation of the target region of the image at each time step. In particular, at each time step, the brain emulation sub-network 208 can process: (i) the target region embedding, and (ii) any outputs generated by the brain emulation sub-network 208 at the preceding time step, to generate the alternative representation of the target region of the image for the time step. The de-noising neural network 204 can provide the alternative representation of the target region of the image generated by the brain emulation sub-network 208 at the final time step as the input to the output sub-network 210. The number of time steps over which the brain emulation sub-network 208 processes the embedding of the target region of the image can be a predetermined hyper-parameter of the image processing system 200.

In addition to processing the alternative representation of the target region of the image generated by the output layer of the brain emulation sub-network 208, the output sub-network 210 can additionally process one or more intermediate outputs of the brain emulation sub-network 208. An intermediate output refers to an output generated by a hidden artificial neuron of the brain emulation sub-network, i.e., an artificial neuron that is not included in the input layer or the output layer of the brain emulation sub-network 208.

As described above, the system 200 can generate the refined training example 214 based on the refined segmentation 212 generated by the de-noising neural network 204. Specifically, the de-noising neural network 204 can process the target region of the image defined by the segmentation included in the training example 202 to generate a de-noised representation of the target region of the image. For example, the system 200 can identify any pixel in the de-noised representation of the target region of the image having a value above a predefined threshold as being included in the target category. The system 200 can identify any pixel in the de-noised representation of the target region of the image having a value below the predefined threshold as not being included in the target category. Accordingly, the refined segmentation 212 of the image, generated by the de-noising neural network 204, can include only those pixels in the target region of the image that are identified as being included in the target category.

For example, the image included in the training example can be a satellite image, the segmentation included in the training example 202 can specify a bounding box in the image that encloses, e.g., electrical power transmission lines, and the refined segmentation 212 for the training example can specify a collection of pixels in the bounding box that are predicted to be included in the electrical transmission lines.

The refined training example 212 can specify: (i) the image in the training example 202, and (ii) the refined segmentation 212 of the target region of the image generated by the de-noising neural network 204 for the training example 202. By processing multiple training examples 202 using the de-noising neural network 204, the image processing system 200 can generate multiple refined training examples 214.

The set of refined training examples 214 can be used in any variety of ways. In one example, the set 214 can be used to train other segmentation machine learning models 220 to generate accurate segmentations, e.g., the pixel-level segmentations generated by the de-noising neural network 204. The segmentation machine learning model 220 can be any appropriate machine learning model, e.g., a neural network model that includes any appropriate types of neural network layers (e.g., fully-connected layers, convolutional layers, attention layers, etc.) in any appropriate numbers (e.g., 1 layer, 5 layers, or 10 layers) and connected in any appropriate configuration (e.g., as a linear sequence of layers). The segmentation machine learning model 220 can be configured to process an image and generate a segmentation of the target category of pixel in the image. The segmentation can define, for each pixel in the image, whether the pixel is included in the target category. The target categories can include one or more of the categories described above.

At each of multiple training iterations of the segmentation machine learning model 220, the training engine 216 can sample a batch (i.e., set) of refined training examples 214 and provide the image in each training example 214 as a model input 218 to the segmentation machine learning model 220. The model 220 can process the respective image included in each refined training example 214 in accordance with a set of parameters of the model 220 to generate a corresponding model output 222. The training engine 214 can train the segmentation machine learning model 220 using any appropriate training technique, e.g., a supervised learning technique.

In some implementations, the training engine 214 can determine gradients of an objective function with respect to the parameters of the segmentation machine learning model 220, where the objective function measures an error between: (i) the model output 222, and (ii) the refined segmentation 212 specified by the refined training example (e.g., generated by the de-noising neural network 204). The training engine 214 can use the gradients of the objective function to update the values of the segmentation machine learning model 220, e.g., to reduce the error measured by the objective function. The error can be, e.g., a cross-entropy error, a squared-error, or any other appropriate error. The training engine 216 can determine the gradients of the objective function with respect to the parameters of the segmentation machine learning model 220, e.g., using backpropagation techniques. The training engine 216 can use the gradients to update parameters of the machine learning model 220 using the update rule of a gradient descent optimization algorithm, e.g., Adam or RMSprop. The aforementioned training scheme is used for illustrative purposes only, and the training engine 216 can train the machine learning model 220 on the refined training examples 214 in any appropriate manner.

By iteratively adjusting the model parameters of the segmentation machine learning model 220, the training engine 216 can train the model 220 to process the image (e.g., the image included in the refined training example 214) and generate an output that matches the refined segmentation 212 generated by the de-noising neural network 204. In this way, the segmentation machine learning model 220 can be trained to perform as effectively at producing refined segmentations as the brain emulation sub-network 208 derived from the brain of the biological organism.

The example architecture of the de-noising neural network 204 and the overall image processing system 200, described with reference to FIG. 2, is provided for illustrative purposes only, and other architectures of the de-noising neural network 204 and of the overall system 200 are possible. For example, the de-noising neural network 204 can include a sequence of multiple different brain emulation sub-networks 208, e.g., each generated by the architecture selection system described below with reference to FIG. 5. Generally, a de-noising neural network 204 can include: (i) one or more brain emulation sub-networks 208 having parameter values derived from a synaptic connectivity graph (e.g., as described below with reference to FIG. 7), and (ii) one or more trainable sub-networks (e.g., the input sub-network 206 and the output sub-network 210).

The brain emulation sub-networks and the trainable sub-networks can be connected in any of a variety of configurations. In some implementations, the de-noising neural network 204 may not include any brain emulation sub-networks 208, and can instead include any other appropriate architecture with any appropriate types of neural network layers (e.g., fully-connected layers, convolutional layers, attention layers, etc.) in any appropriate numbers (e.g., 1 layer, 5 layers, or 10 layers) and connected in any appropriate configuration (e.g., as a linear sequence of layers). The training examples used to generate the refined segmentations 212, and the refined training examples 214 for training the segmentation machine learning model 220, will be described in more detail next.

FIG. 3 illustrates a training example including: (i) an image 302 and (ii) a segmentation 304, and a refined segmentation 306 generated by a de-noising neural network, e.g., the de-noising neural network 204 in FIG. 2. The image 302 can be captured by using any of a variety of imaging modalities. For example, the image 302 can be a visible light image, an infrared image, or a hyperspectral image. The image 302 can be represented, e.g., as an array of numerical values.

The image 302 can be, e.g., a high-resolution satellite image of a scene including one or more objects of interest, e.g., power transmission lines 310. The segmentation 304 can define a target region of the image, e.g., specified by a bounding box enclosing a region of the image, that has been classified, e.g., by manual human annotation, as including pixels in the target category (e.g., power transmission lines 310). As described above, the segmentation 304 can include at least some pixels that are not included in the target category. For example, the target region can include both: (i) power transmission lines 310, and (ii) background vegetation and structures in proximity to the power transmission lines 310.

As described above with reference to FIG. 2, a de-noising neural network, having a brain emulation sub-network, can process the target region in the image 304 included in the training example to generate a refined segmentation 306 of the target region in the image. The refined segmentation 306 can more precisely define each of the objects of interest in the image, e.g., define each of the power transmission lines 310 at pixel-level resolution in the target region in the image.

As described above with reference to FIG. 2, the image 302 and the refined segmentation 306 (e.g., collectively referred to as a refined training example) can be used to train a segmentation machine learning model to generate a model output that matches the refined segmentation 306 generated by the de-noising neural network, e.g., a pixel-level segmentation of an object of interest in the image. After training, the segmentation machine learning model may be able to process the image 302 and generate an output that matches the refined segmentation 306. Training the segmentation machine learning model using the refined segmentations 306 enables the model to segment the target category of pixels more accurately, e.g., by generating a pixel-wise segmentation of the target pixels (e.g., pixels included in the category of “power transmission lines” 310), rather than only a bounding box that encloses the target pixels along with other pixels (e.g., pixels that represent other objects in the image, such as background vegetation and structures). The process for training a segmentation machine learning model to generate an output that matches the refined segmentation 306 will be described in more detail next.

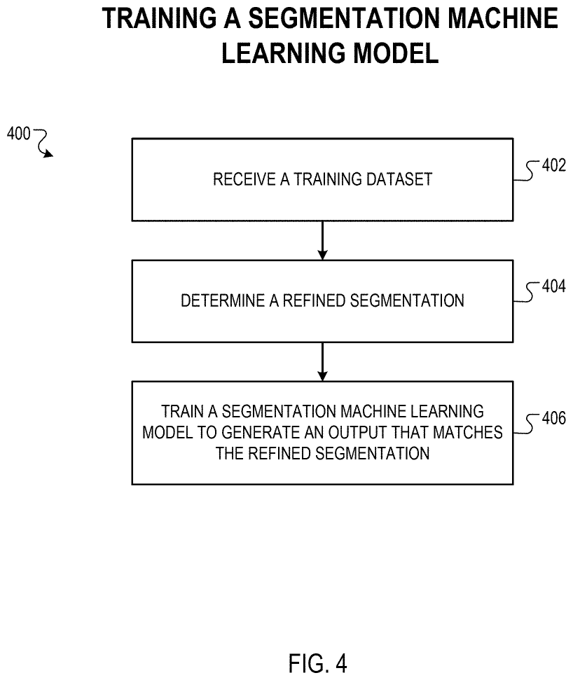

FIG. 4 is a flow diagram of an example process 400 for training a segmentation machine learning model to generate a model output that matches a refined segmentation. For convenience, the process 400 will be described as being performed by a system of one or more computers located in one or more locations. For example, an image processing system, e.g., the system 130 in FIG. 1 or the system 200 of FIG. 2, appropriately programmed in accordance with this specification, can perform the process 500.

The system receives a training dataset that includes multiple training examples (402). Each training example can include an image (e.g., the image 302 in FIG. 3) and a segmentation (e.g., the segmentation 304 in FIG. 3) defining a target region of the image that has been classified as including pixels in a target category (e.g., power lines). In some implementations, the segmentation can be generated by human annotation.

The system determines a respective refined segmentation (e.g., the refined segmentation 306 in FIG. 3) for each training example (404). For each training example, the system can process the target region of the image defined by the segmentation for the training example using a de-noising neural network (e.g., the de-noising neural network 204 in FIG. 2) to generate a network output that defines the refined segmentation for the training example. As described above, the de-noising neural network can include a brain emulation sub-network having a brain emulation neural network architecture that is based on synaptic connectivity between biological neurons in a brain of a biological organism (e.g., the brain 104 of the biological organism 102 in FIG. 1). The segmentation included in the training example can specify a bounding box that encloses the target region of the image of the training example. The refined segmentation for the training example can define a refined target region of the image that is a proper subset of the target region of the image of the training example, e.g., the refined target region can have an area that is less than 10% of an area of the target region of the image.

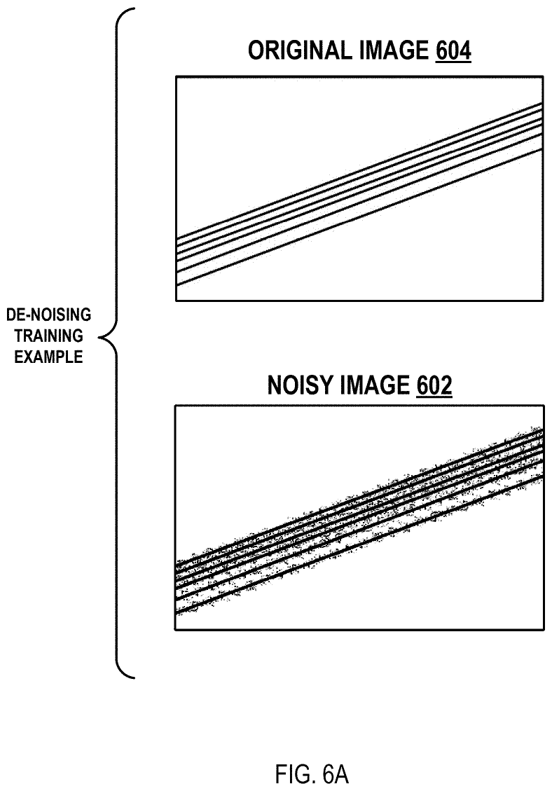

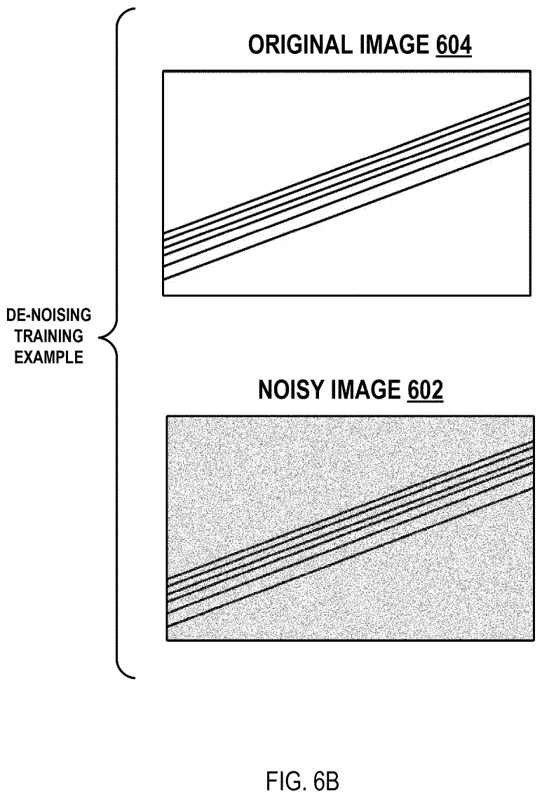

In some implementations, the image can be a satellite image, the segmentation included in the training example can specify a bounding box in the image that encloses electrical power transmission lines, and the refined segmentation can specify a collection of pixels in the bounding box that are predicted to be included in the electrical transmission lines. As described in more detail below with reference to FIG. 5, the de-noising neural network can be trained to perform a de-noising task. For example, the de-noising neural network can be trained by obtaining multiple de-noising training examples (e.g., the de-noising training examples shown in FIGS. 6A and 6B).

Each de-noising training example can include an original image (e.g., a synthetic image) and a noisy image that is generated by combining noise with the original image, e.g., by adding Gaussian noise to the original image. Training the de-noising neural network on multiple de-noising training examples can include, for each de-noising training example, training the de-noising neural network to process the noisy image to generate an output that matches the original image from the de-noising training example. During training of the de-noising neural network, the noisy image can be processed to generate a predicted image, and an update to values of multiple de-noising neural network parameters can be determined based on an error between: (i) the predicted image and (ii) the original image.

The system trains a segmentation machine learning model (e.g., the model 220 in FIG. 2) on the training examples of the training dataset (406). For each training example, the system can train the segmentation machine learning model to process the image included in the training example to generate a model output that matches the refined segmentation for the training example. After training, the segmentation machine learning model may be able to process any type of image to generate precise, pixel-level segmentations.

An example architecture selection system, that can be used to generate a brain emulation neural network (e.g., the network 120 in FIG. 1 or the sub-network 208 in FIG. 2) for inclusion in the de-noising neural network, will be described in more detail next.

FIG. 5 is a block diagram of an example architecture selection system 500. The architecture selection system 500 is an example of a system implemented as computer programs on one or more computers in one or more locations in which the systems, components, and techniques described below are implemented.

The system 500 is configured to search a space of possible neural network architectures to identify the neural network architecture of a brain emulation neural network 520 (e.g., the network 120 in FIG. 1 or the sub-network 208 in FIG. 2) to be included in a de-noising neural network in an image processing system (e.g., the system 130 in FIG. 1 or the system 200 in FIG. 2). In one example, the system 500 can be configured to identify a region of the brain of the biological organism that is effective at performing a particular image processing task, e.g., a de-noising task.

The system 500 seeds the search through the space of possible neural network architectures using a synaptic connectivity graph 508 (e.g., the graph 108 in FIG. 1 or the graph 708 in FIG. 7) representing synaptic connectivity in the brain of a biological organism. The synaptic connectivity graph 508 can be derived directly from a synaptic resolution image of the brain of a biological organism, e.g., as described below with reference to FIG. 7. In some cases, the synaptic connectivity graph 508 can be a sub-graph of a larger graph derived from a synaptic resolution image of a brain, e.g., a sub-graph that includes neurons of a particular type, e.g., visual neurons. (As used throughout this specification, a “sub-graph” refers to a graph that includes a proper subset of the nodes and the edges of a larger graph).

The system 500 includes a graph generation engine 502, an architecture mapping engine 504, a training engine 514, and a selection engine 518, each of which will be described in more detail next.

The graph generation engine 502 is configured to process the synaptic connectivity graph 508 to generate multiple candidate graphs 510, where each candidate graph is defined by a set of nodes and a set of edges, such that each edge connects a pair of nodes. The graph generation engine 502 can generate the candidate graphs 510 from the synaptic connectivity graph 508 using any of a variety of techniques. A few examples follow.

In one example, the graph generation engine 502 can generate a candidate graph 510 at each of multiple iterations by processing the synaptic connectivity graph 508 in accordance with current values of a set of graph generation parameters. The current values of the graph generation parameters can specify (transformation) operations to be applied to an adjacency matrix representing the synaptic connectivity graph 508 to generate an adjacency matrix representing a candidate graph 510. The operations to be applied to the adjacency matrix representing the synaptic connectivity graph can include, e.g., filtering operations, cropping operations, or both. The candidate graph 510 can be defined by the result of applying the operations specified by the current values of the graph generation parameters to the adjacency matrix representing the synaptic connectivity graph 508.

The graph generation engine 502 can apply a filtering operation to the adjacency matrix representing the synaptic connectivity graph 508, e.g., by convolving a filtering kernel with the adjacency matrix representing the synaptic connectivity graph. The filtering kernel can be defined by a two-dimensional matrix, where the components of the matrix are specified by the graph generation parameters. Applying a filtering operation to the adjacency matrix representing the synaptic connectivity graph 508 can have the effect of adding edges to the synaptic connectivity graph 508, removing edges from the synaptic connectivity graph 508, or both.

The graph generation engine 502 can apply a cropping operation to the adjacency matrix representing the synaptic connectivity graph 508, where the cropping operation replaces the adjacency matrix representing the synaptic connectivity graph 508 with an adjacency matrix representing a sub-graph of the synaptic connectivity graph 508. The cropping operation can specify a sub-graph of synaptic connectivity graph 508, e.g., by specifying a proper subset of the rows and a proper subset of the columns of the adjacency matrix representing the synaptic connectivity graph 508 that define a sub-matrix of the adjacency matrix. The sub-graph can include: (i) each edge specified by the sub-matrix, and (ii) each node that is connected by an edge specified by the sub-matrix.

At each iteration, the system 500 determines a performance measure 516 corresponding to the candidate graph 510 generated at the iteration, and the system 500 updates the current values of the graph generation parameters to encourage the generation of candidate graphs 510 with higher performance measures 516. The performance measure 516 for a candidate graph 510 characterizes the performance of a de-noising neural network that includes a brain emulation neural network having an architecture specified by the candidate graph 510 at processing images to perform a de-noising task. Determining performance measures 516 for candidate graphs 510 will be described in more detail below.

The system 500 can use any appropriate optimization technique to update the current values of the graph generation parameters, e.g., a “black-box” optimization technique that does not rely on computing gradients of the operations performed by the graph generation engine 502. Examples of black-box optimization techniques which can be implemented by the optimization engine are described with reference to: Golovin, D., Solnik, B., Moitra, S., Kochanski, G., Karro, J., & Sculley, D.: “Google vizier: A service for black-box optimization,” In Proceedings of the 23rd ACM SIGKDD International Conference on Knowledge Discovery and Data Mining, pp. 1487-1495 (2017). Prior to the first iteration, the values of the graph generation parameters can be set to default values or randomly initialized.

In another example, the graph generation engine 502 can generate the candidate graphs 510 by “evolving” a population (i.e., a set) of graphs derived from the synaptic connectivity graph 508 over multiple iterations. The graph generation engine 502 can initialize the population of graphs, e.g., by “mutating” multiple copies of the synaptic connectivity graph 508. Mutating a graph refers to making a random change to the graph, e.g., by randomly adding or removing edges or nodes from the graph. After initializing the population of graphs, the graph generation engine 502 can generate a candidate graph at each of multiple iterations by, at each iteration, selecting a graph from the population of graphs derived from the synaptic connectivity graph and mutating the selected graph to generate a candidate graph 510. The graph generation engine 502 can determine a performance measure 516 for the candidate graph 510, and use the performance measure to determine whether the candidate graph 510 is added to the current population of graphs.

In some implementations, each edge of the synaptic connectivity graph 508 can be associated with a weight value that is determined from the synaptic resolution image of the brain, as described below with reference to FIG. 7. Each candidate graph 510 can inherit the weight values associated with the edges of the synaptic connectivity graph 508. For example, each edge in the candidate graph 510 that corresponds to an edge in the synaptic connectivity graph 508 can be associated with the same weight value as the corresponding edge in the synaptic connectivity graph 508. Edges in the candidate graph 510 that do not correspond to edges in the synaptic connectivity graph 508 can be associated with default or randomly initialized weight values.

In some implementations, each candidate graph 510 is a randomly selected sub-graph of the synaptic connectivity graph, e.g., corresponding to a randomly selected sub-matrix of the adjacency matrix representing the synaptic connectivity graph.

The architecture mapping engine 504 processes each candidate graph 510 to generate a corresponding brain emulation neural network architecture 506. The architecture mapping engine 504 can use the candidate graph 510 derived from the synaptic connectivity graph 508 to specify the brain emulation neural network architecture 506 in any of a variety of ways. For example, the architecture mapping engine can map each node in the candidate graph 510 to a corresponding: (i) artificial neuron, (ii) artificial neural network layer, or (iii) group of artificial neural network layers in the brain emulation neural network architecture, as will be described in more detail next.

In one example, the brain emulation neural network architecture 506 can include: (i) a respective artificial neuron corresponding to each node in the candidate graph 510, and (ii) a respective connection corresponding to each edge in the candidate graph 510. In this example, the candidate graph 510 can be a directed graph, and an edge that points from a first node to a second node in the candidate graph 510 can specify a connection pointing from a corresponding first artificial neuron to a corresponding second artificial neuron in the brain emulation neural network architecture 506.

The connection pointing from the first artificial neuron to the second artificial neuron can indicate that the output of the first artificial neuron should be provided as an input to the second artificial neuron. Each connection in the brain emulation neural network architecture can be associated with a weight value, e.g., that is specified by the weight value associated with the corresponding edge in the candidate graph. An artificial neuron can refer to a component of the brain emulation neural network architecture that is configured to receive one or more inputs (e.g., from one or more other artificial neurons), and to process the inputs to generate an output. The inputs to an artificial neuron and the output generated by the artificial neuron can be represented as scalar numerical values. In one example, a given artificial neuron can generate an output b as:

$$b = σ ( {\sum }_{i = 1}^{n} {w}_{i} \cdot {a}_{i} ) \qquad ( 1 )$$

where δ(⋅)a non-linear “activation” function (e.g., a sigmoid function or an arctangent function), {aᵢᵢ₌₁ⁿ } are the inputs provided to the given artificial neuron, and {wᵢ}ᵢ₌₁ⁿ are the weight values associated with the connections between the given artificial neuron and each of the other artificial neurons that provide an input to the given artificial neuron.

In another example, the candidate graph 510 can be an undirected graph, and the architecture mapping engine 504 can map an edge that connects a first node to a second node in the candidate graph 510 to two connections between a corresponding first artificial neuron and a corresponding second artificial neuron in the brain emulation neural network architecture. In particular, the architecture mapping engine 504 can map the edge to: (i) a first connection pointing from the first artificial neuron to the second artificial neuron, and (ii) a second connection pointing from the second artificial neuron to the first artificial neuron.

In another example, the candidate graph 510 can be an undirected graph, and the architecture mapping engine can map an edge that connects a first node to a second node in the candidate graph 510 to one connection between a corresponding first artificial neuron and a corresponding second artificial neuron in the brain emulation neural network architecture. The architecture mapping engine can determine the direction of the connection between the first artificial neuron and the second artificial neuron, e.g., by randomly sampling the direction in accordance with a probability distribution over the set of two possible directions.

In another example, the brain emulation neural network architecture can include: (i) a respective artificial neural network layer corresponding to each node in the candidate graph 510, and (ii) a respective connection corresponding to each edge in the candidate graph 510. In this example, a connection pointing from a first layer to a second layer can indicate that the output of the first layer should be provided as an input to the second layer. An artificial neural network layer can refer to a collection of artificial neurons, and the inputs to a layer and the output generated by the layer can be represented as ordered collections of numerical values (e.g., tensors of numerical values). In one example, the brain emulation neural network architecture can include a respective convolutional neural network layer corresponding to each node in the candidate graph 510, and each given convolutional layer can generate an output d as:

$$d = σ ( {h}_{θ} ( {\sum }_{i = 1}^{n} {w}_{i} \cdot {c}_{i} ) ) \qquad ( 2 )$$

where each cᵢ(i=1, . . . , n) is a tensor (e.g., a two- or three-dimensional array) of numerical values provided as an input to the layer, each wᵢ(i=1, . . . , n) is a weight value associated with the connection between the given layer and each of the other layers that provide an input to the given layer (where the weight value for each connection can be specified by the weight value associated with the corresponding edge in the candidate graph), represents the operation of applying one or more convolutional kernels to an input to generate a corresponding output, and δ(⋅) is a non-linear activation function that is applied element-wise to each component of its input. In this example, each convolutional kernel can be represented as an array of numerical values, e.g., where each component of the array is randomly sampled from a predetermined probability distribution, e.g., a standard Normal probability distribution.

In another example, the architecture mapping engine 504 can determine that the brain emulation neural network architecture includes: (i) a respective group of artificial neural network layers corresponding to each node in the candidate graph 510, and (ii) a respective connection corresponding to each edge in the candidate graph 510. The layers in a group of artificial neural network layers corresponding to a node in the candidate graph 510 can be connected, e.g., as a linear sequence of layers, or in any other appropriate manner.

When the graph specifying the architecture of the brain emulation neural network is a synaptic connectivity graph (or a sub-graph of a synaptic connectivity graph), then the architecture of the brain emulation neural network can directly represent synaptic connectivity in a region of the brain of the biological organism. More specifically, the engine 504 can map the nodes of the synaptic connectivity graph (which each represent a biological neuron or group of biological neurons in the brain) onto corresponding artificial neurons in the brain emulation neural network. The engine 504 can also map the edges of the synaptic connectivity graph (which each represent a synaptic connection between a pair of biological neurons or groups of biological neurons in the brain) onto connections between corresponding pairs of artificial neurons in the brain emulation neural network. The engine 504 can map the respective weight associated with each edge in the synaptic connectivity graph to a corresponding weight (i.e., parameter value) of a corresponding connection in the brain emulation neural network. The weight corresponding to an edge (representing a synaptic connection in the brain) between a pair of nodes in the synaptic connectivity graph (representing a pair of biological neurons or two groups of biological neurons in the brain) can represent a proximity of the pair of biological neurons or groups of neurons in the brain, as described above.

For each brain emulation neural network architecture 506, the training engine 514 instantiates a de-noising neural network 512 (e.g., implemented as a reservoir computing neural network) that includes a brain emulation sub-network having the brain emulation neural network architecture 506. Examples of de-noising neural networks that include brain emulation sub-networks are described in more detail with reference to FIG. 2. The training engine 514 is configured to train each de-noising neural network 512 to perform a de-noising task over multiple training iterations.

Specifically, the training engine 514 can train each de-noising neural network 512 on a set of de-noising training examples, e.g., illustrated in FIGS. 6A and 6B. Each de-noising training example can include (i) an original image 604 and (ii) a noisy image 602 that is generated by combining noise with the original image. The images can be, e.g., synthetic images. For each de-noising training example, the original image 604 can be generated by, e.g., adding a number of random lines (e.g., representing power lines), or adding a number of squares (e.g., representing buildings), or any other appropriate shape, to an otherwise empty binary image. The noisy image 602 can be generated by adding Gaussian noise to the original image 604 included in the de-noising training example. Generally, the de-noising training examples can have any form and can be generated according to a particular de-noising task that the brain emulation neural network 520 (or an image processing system that includes the brain emulation neural network, such as the system 200 in FIG. 2) will be required to perform. For example, the images in the de-noising training examples can represent low-resolution approximations of images that the brain emulation neural network 520 will be required to process after training.

For example, if the de-noising task is generating a pixel-level resolution segmentation of power lines in a satellite image, the noisy image 602 can be a low-resolution image that includes one or more directed lines representing the power lines and further includes noise. Each de-noising neural network 512 can process the noisy image 602 and generate a refined segmentation of the noisy image 602, e.g., an image that corresponds to the original image 604 without any noise. In some implementations, the images in the de-noising training examples can be, e.g., panchromatic images. Training each de-noising neural network 512 on images that have low resolution (e.g., when compared to natural images, such as satellite images) can facilitate automatically and efficiently evaluating each de-noising neural network 512, because processing low resolution images can be less computationally intensive than processing high resolution images.

At each of multiple training iterations, the training engine 514 can sample a batch (i.e., set) of de-noising training examples and process the respective noisy image 602 included in each example using the de-noising neural network 512 to generate a corresponding de-noising prediction, e.g., an image that corresponds to the original image 604 without any noise. The training engine 514 can determine gradients of an objective function with respect to the de-noising neural network parameters, where the objective function measures an error between: (i) the de-noising prediction generated by the de-noising neural network, and (ii) the original image 604 without any noise specified by the training example.

The training engine 514 can use the gradients of the objective function to update the values of the de-noising neural network parameters, e.g., to reduce the error measured by the objective function. The error can be, e.g., a cross-entropy error, a squared-error, or any other appropriate error. The training engine 514 can determine the gradients of the objective function with respect to the de-noising neural network parameters, e.g., using backpropagation techniques. The training engine 514 can use the gradients to update the de-noising neural network parameters using the update rule of a gradient descent optimization algorithm, e.g., Adam or RMSprop.

During training of each de-noising neural networks 512, the parameter values of the input sub-network and the output sub-network are trained, but some or all of the parameter values of the brain emulation sub-network can be static, i.e., not trained. Instead of being trained, the parameter values of the brain emulation sub-network can be determined from the weight values of the edges of the synaptic connectivity graph, as will be described in more detail below with reference to FIG. 7. The de-noising neural network 512 can harness the capacity of the brain emulation sub-network, e.g., to generate representations that are effective for de-noising images, without requiring the brain emulation sub-network to be trained.

The training engine 514 can use any of a variety of regularization techniques during training of each de-noising neural network 512. For example, the training engine 514 can use a dropout regularization technique, such that certain artificial neurons of the brain emulation sub-network are “dropped out” (e.g., by having their output set to zero) with a non-zero probability p>0 each time the brain emulation sub-network processes an input. Using the dropout regularization technique can improve the performance of the trained de-noising neural network 512, e.g., by reducing the likelihood of over-fitting. An example dropout regularization technique is described with reference to: N. Srivastava, et al.: “Dropout: a simple way to prevent neural networks from overfitting,” Journal of Machine Learning Research 15 (2014) 1929-1958. As another example, the training engine 514 can regularize the training of each de-noising neural network by including a “penalty” term in the objective function that measures the magnitude of the parameter values of the input sub-network, the output sub-network, or both. The penalty term can be, e.g., an L_1 or L_2 norm of the parameter values of the input sub-network, the output sub-network, or both.

In some cases, the values of the intermediate outputs of the brain emulation sub-network can have large magnitudes, e.g., as a result of the parameter values of the brain emulation sub-network being derived from the weight values of the edges of the synaptic connectivity graph rather than being trained. Therefore, to facilitate training of the de-noising neural network, batch normalization layers can be included between the layers of the brain emulation sub-network, which can contribute to limiting the magnitudes of intermediate outputs generated by the brain emulation sub-network. Alternatively or in combination, the activation functions of the neurons of the brain emulation sub-network can be selected to have a limited range. For example, the activation functions of the neurons of the brain emulation sub-network can be selected to be sigmoid activation functions with range given by [0,1].

The training engine 514 determines a respective performance measure 516 of each de-noising neural network 512 on the de-noising task. For example, the training engine 514 can determine the performance measure 516 based on the respective error (e.g., cross-entropy or L2 error) between: (i) the output generated by the de-noising neural network 512 for the noisy image 602, and (ii) the original image 604 without noise, for each de-noising training example. The training engine 514 can determine the performance measure 516, e.g., as the average error or the maximum error over the de-noising training examples. The performance measure of each de-noising neural network 512 is determined on a set of validation data that is not used during training of each de-noising neural network 512.

The selection engine 518 uses the performance measures 516 to generate the output brain emulation neural network 520. In one example, the selection engine 518 can generate a brain emulation neural network 520 having the brain emulation neural network architecture 506 associated with the best (e.g., highest) performance measure 516. The architecture selection system 500 can generate a brain emulation neural network 520 that is tuned for effective performance on the specific de-noising prediction task. As described above, the architecture of the brain emulation neural network can be based on a synaptic connectivity graph that represents synaptic connectivity in the brain of a biological organism. An example data flow for generating the synaptic connectivity graph of a synaptic resolution image of the brain will be described in more detail next.

FIG. 7 is an example data flow 700 for generating a synaptic connectivity graph 708 based on the brain 702 of a biological organism. An imaging system 704 can be used to generate a synaptic resolution image 706 of the brain 702. An image of the brain 702 can be referred to as having synaptic resolution if it has a spatial resolution that is sufficiently high to enable the identification of at least some synapses in the brain 702. Put another way, an image of the brain 702 can be referred to as having synaptic resolution if it depicts the brain 702 at a magnification level that is sufficiently high to enable the identification of at least some synapses in the brain 702. The image 706 can be a volumetric image, i.e., that characterizes a three-dimensional representation of the brain 702. The image 706 can be represented in any appropriate format, e.g., as a three-dimensional array of numerical values.

The imaging system 704 can be any appropriate system capable of generating synaptic resolution images, e.g., an electron microscopy system. The imaging system 704 can process “thin sections” from the brain 702 (i.e., thin slices of the brain attached to slides) to generate output images that each have a field of view corresponding to a proper subset of a thin section. The imaging system 704 can generate a complete image of each thin section by stitching together the images corresponding to different fields of view of the thin section using any appropriate image stitching technique. The imaging system 704 can generate the volumetric image 706 of the brain by registering and stacking the images of each thin section. Registering two images refers to applying transformation operations (e.g., translation or rotation operations) to one or both of the images to align them. Example techniques for generating a synaptic resolution image of a brain are described with reference to: Z. Zheng, et al., “A complete electron microscopy volume of the brain of adult Drosophila melanogaster,” Cell 174, 730-743 (2018).

In some implementations, the imaging system 704 can be a two-photon endomicroscopy system that utilizes a miniature lens implanted into the brain to perform fluorescence imaging. This system enables in-vivo imaging of the brain at the synaptic resolution. Example techniques for generating a synaptic resolution image of the brain using two-photon endomicroscopy are described with reference to: Z. Qin, et al., “Adaptive optics two-photon endomicroscopy enables deep-brain imaging at synaptic resolution over large volumes,” Science Advances, Vol. 6, no. 40, doi: 10.1126/sciadv.abc6521.

A graphing system 710 is configured to process the synaptic resolution image 706 to generate the synaptic connectivity graph 708. The synaptic connectivity graph 708 specifies a set of nodes and a set of edges, such that each edge connects two nodes. To generate the graph 708, the graphing system 710 identifies each neuron in the image 706 as a respective node in the graph, and identifies each synaptic connection between a pair of neurons in the image 706 as an edge between the corresponding pair of nodes in the graph.

The graphing system 710 can identify the neurons and the synapses depicted in the image 706 using any of a variety of techniques. For example, the graphing system 710 can process the image 706 to identify the positions of the neurons depicted in the image 706, and determine whether a synapse connects two neurons based on the proximity of the neurons (as will be described in more detail below). In this example, the graphing system 710 can process an input including: (i) the image, (ii) features derived from the image, or (iii) both, using a segmentation machine learning model that is trained using supervised learning techniques to identify neurons in images. The segmentation machine learning model can be, e.g., a convolutional neural network model or a random forest model. The output of the segmentation machine learning model can include a neuron probability map that specifies a respective probability that each voxel in the image is included in a neuron. The graphing system 710 can identify contiguous clusters of voxels in the neuron probability map as being neurons.

Optionally, prior to identifying the neurons from the neuron probability map, the graphing system 710 can apply one or more filtering operations to the neuron probability map, e.g., with a Gaussian filtering kernel. Filtering the neuron probability map can reduce the amount of “noise” in the neuron probability map, e.g., where only a single voxel in a region is associated with a high likelihood of being a neuron.

The segmentation machine learning model used by the graphing system 710 to generate the neuron probability map can be trained using supervised learning training techniques on a set of training data. The training data can include a set of training examples, where each training example specifies: (i) a training input that can be processed by the segmentation machine learning model, and (ii) a target output that should be generated by the segmentation machine learning model by processing the training input. For example, the training input can be a synaptic resolution image of a brain, and the target output can be a “label map” that specifies a label for each voxel of the image indicating whether the voxel is included in a neuron. The target outputs of the training examples can be generated by manual annotation, e.g., where a person manually specifies which voxels of a training input are included in neurons.

Example techniques for identifying the positions of neurons depicted in the image 706 using neural networks (in particular, flood-filling neural networks) are described with reference to: P. H. Li et al.: “Automated Reconstruction of a Serial-Section EM Drosophila Brain with Flood-Filling Networks and Local Realignment,” bioRxiv doi:10.1101/605634 (2019).

The graphing system 710 can identify the synapses connecting the neurons in the image 706 based on the proximity of the neurons. For example, the graphing system 710 can determine that a first neuron is connected by a synapse to a second neuron based on the area of overlap between: (i) a tolerance region in the image around the first neuron, and (ii) a tolerance region in the image around the second neuron. That is, the graphing system 710 can determine whether the first neuron and the second neuron are connected based on the number of spatial locations (e.g., voxels) that are included in both: (i) the tolerance region around the first neuron, and (ii) the tolerance region around the second neuron. For example, the graphing system 710 can determine that two neurons are connected if the overlap between the tolerance regions around the respective neurons includes at least a predefined number of spatial locations (e.g., one spatial location). A “tolerance region” around a neuron refers to a contiguous region of the image that includes the neuron. For example, the tolerance region around a neuron can be specified as the set of spatial locations in the image that are either: (i) in the interior of the neuron, or (ii) within a predefined distance of the interior of the neuron.

The graphing system 710 can further identify a weight value associated with each edge in the graph 708. For example, the graphing system 710 can identify a weight for an edge connecting two nodes in the graph 708 based on the area of overlap between the tolerances regions around the respective neurons corresponding to the nodes in the image 706. The area of overlap can be measured, e.g., as the number of voxels in the image 706 that are contained in the overlap of the respective tolerance regions around the neurons. The weight for an edge connecting two nodes in the graph 708 can be understood as characterizing the (approximate) strength of the connection between the corresponding neurons in the brain (e.g., the amount of information flow through the synapse connecting the two neurons).

In addition to identifying synapses in the image 706, the graphing system 710 can further determine the direction of each synapse using any appropriate technique. The “direction” of a synapse between two neurons refers to the direction of information flow between the two neurons, e.g., if a first neuron uses a synapse to transmit signals to a second neuron, then the direction of the synapse would point from the first neuron to the second neuron. Example techniques for determining the directions of synapses connecting pairs of neurons are described with reference to: C. Seguin, A. Razi, and A. Zalesky: “Inferring neural signalling directionality from undirected structure connectomes,” Nature Communications 10, 4289 (2019), doi:10.1038/s41467-019-12201-w.

In implementations where the graphing system 710 determines the directions of the synapses in the image 706, the graphing system 710 can associate each edge in the graph 708 with the direction of the corresponding synapse. That is, the graph 708 can be a directed graph. In other implementations, the graph 708 can be an undirected graph, i.e., where the edges in the graph are not associated with a direction.

The graph 708 can be represented in any of a variety of ways. For example, the graph 708 can be represented as a two-dimensional array of numerical values with a number of rows and columns equal to the number of nodes in the graph. The component of the array at position (i, j) can have value 1 if the graph includes an edge pointing from node i to node j, and value 0 otherwise. In implementations where the graphing system 710 determines a weight value for each edge in the graph 708, the weight values can be similarly represented as a two-dimensional array of numerical values. More specifically, if the graph includes an edge connecting node i to node j, the component of the array at position (i, j) can have a value given by the corresponding edge weight, and otherwise the component of the array at position (i, j) can have value 0.

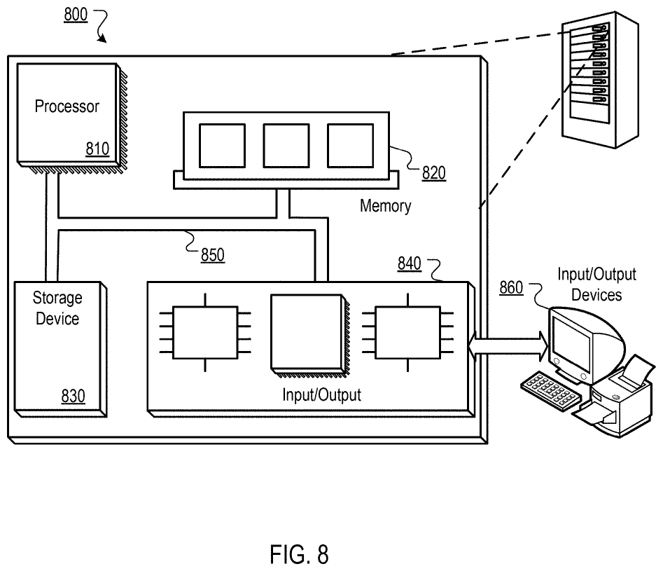

FIG. 8 is a block diagram of an example computer system 800 that can be used to perform operations described previously. The system 800 includes a processor 810, a memory 820, a storage device 830, and an input/output device 840. Each of the components 810, 820, 830, and 840 can be interconnected, for example, using a system bus 850. The processor 810 is capable of processing instructions for execution within the system 800. In one implementation, the processor 810 is a single-threaded processor. In another implementation, the processor 810 is a multi-threaded processor. The processor 810 is capable of processing instructions stored in the memory 820 or on the storage device 830.

The memory 820 stores information within the system 800. In one implementation, the memory 820 is a computer-readable medium. In one implementation, the memory 820 is a volatile memory unit. In another implementation, the memory 820 is a non-volatile memory unit.

The storage device 830 is capable of providing mass storage for the system 800. In one implementation, the storage device 830 is a computer-readable medium. In various different implementations, the storage device 830 can include, for example, a hard disk device, an optical disk device, a storage device that is shared over a network by multiple computing devices (for example, a cloud storage device), or some other large capacity storage device.

The input/output device 840 provides input/output operations for the system 800. In one implementation, the input/output device 840 can include one or more network interface devices, for example, an Ethernet card, a serial communication device, for example, and RS-232 port, and/or a wireless interface device, for example, and 802.11 card. In another implementation, the input/output device 840 can include driver devices configured to receive input data and send output data to other input/output devices, for example, keyboard, printer and display devices 860. Other implementations, however, can also be used, such as mobile computing devices, mobile communication devices, and set-top box television client devices.

Although an example processing system has been described in FIG. 8, implementations of the subject matter and the functional operations described in this specification can be implemented in other types of digital electronic circuitry, or in computer software, firmware, or hardware, including the structures disclosed in this specification and their structural equivalents, or in combinations of one or more of them.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which can also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program can, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, e.g., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what can be claimed, but rather as descriptions of features that can be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and even initially be claimed as such, one or more features from a claimed combination can in some cases be excised from the combination, and the claimed combination can be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing can be advantageous.

What is claimed is:

1. A method performed by one or more data processing apparatus, the method comprising:
receiving a training dataset comprising a plurality of training examples, wherein each training example comprises: (i) an image, and (ii) a segmentation defining a target region of the image that has been classified as including pixels in a target category;
determining a respective refined segmentation for each training example, comprising, for each training example:
processing the target region of the image defined by the segmentation for the training example using a de-noising neural network to generate a network output that defines the refined segmentation for the training example,
wherein the de-noising neural network comprises a brain emulation sub-network having a brain emulation neural network architecture that is based on synaptic connectivity between biological neurons in a brain of a biological organism; and
training a segmentation machine learning model on the training examples of the training dataset, comprising, for each training example:
training the segmentation machine learning model to process the image included in the training example to generate a model output that matches the refined segmentation for the training example.

2. The method of 1, wherein for each of the plurality of training examples, the segmentation included in the training example specifies a bounding box that encloses the target region of the image of the training example.

3. The method of claim 1, for each of the plurality of training examples, the refined segmentation for the training example defines a refined target region of the image that is a proper subset of the target region of the image of the training example.

4. The method of claim 3, wherein for each of the plurality of training examples, the refined target region of the image has an area that is less than 10% of an area of the target region of the image.

5. The method of claim 3, wherein for each of the plurality of training examples:
the image included in the training example is a satellite image;
the segmentation included in the training example specifies a bounding box in the image that encloses electrical power transmission lines; and
the refined segmentation for the training example specifies a collection of pixels in the bounding box that are predicted to be included in the electrical transmission lines.

6. The method of claim 1, wherein the de-noising neural network has been trained to perform a de-noising task, comprising:
obtaining a plurality of de-noising training examples, wherein each de-noising training example comprises: (i) an original image, and (ii) a noisy image that is generated by combining noise with the original image; and
training the de-noising neural network on the plurality of de-noising training examples, comprising, for each de-noising training example:
training the de-noising neural network to process the noisy image from the de-noising training example to generate an output that matches the original image from the de-noising training example.

7. The method of claim 6, wherein for each de-noising training example, training the de-noising neural network to process the noisy image from the de-noising training example to generate an output that matches the original image from the de-noising training example comprises:
processing the noisy image using the de-noising neural network to generate a predicted image; and
determining an update to values of a plurality of de-noising neural network parameters based on an error between: (i) the predicted image, and (ii) the original image.

8. The method of claim 7, wherein for each of the plurality of de-noising training examples, the noisy image included in the de-noising training example is generated by adding Gaussian noise to the original image included in the de-noising training example.

9. The method of claim 7, wherein for each of the plurality of de-noising training examples, the original image included in the training example is a synthetic image.

10. The method of claim 1, wherein for each of the plurality of training examples, the segmentation is generated by manual annotation.

11. The method of claim 1, wherein the brain emulation neural network architecture is determined from a synaptic connectivity graph that represents the synaptic connectivity between the biological neurons in the brain of the biological organism.

12. The method of claim 11, wherein the synaptic connectivity graph comprises a plurality of nodes and edges, each edge connects a pair of nodes, each node corresponds to a respective neuron or group of neurons in the brain of the biological organism, and each edge connecting a pair of nodes in the synaptic connectivity graph corresponds to a synaptic connection between a pair of biological neurons or groups of biological neurons in the brain of the biological organism.

13. The method of claim 12, wherein the synaptic connectivity graph is generated by a plurality of operations comprising:
obtaining a synaptic resolution image of at least a portion of the brain of the biological organism; and
processing the image to identify: (i) a plurality of neurons in the brain, and (ii) a plurality of synaptic connections between pairs of neurons in the brain.

14. The method of claim 12, wherein determining the brain emulation neural network architecture from the synaptic connectivity graph comprises:
mapping each node in the synaptic connectivity graph to a corresponding artificial neuron in the brain emulation neural network architecture; and
mapping each edge in the synaptic connectivity graph to a connection between a corresponding pair of artificial neurons in the brain emulation neural network architecture.

15. The method of claim 14, wherein determining the brain emulation neural network architecture from the synaptic connectivity graph further comprises:
instantiating a respective parameter value associated with each connection between a pair of artificial neurons in the brain emulation neural network architecture that is based on a respective proximity between a corresponding pair of biological neurons or groups of biological neurons in the brain of the biological organism.

16. The method of claim 12, wherein determining the brain emulation neural network architecture from the synaptic connectivity graph comprises:
generating data defining a plurality of candidate graphs based on the synaptic connectivity graph;
determining, for each candidate graph, a performance measure on a segmentation task of an instance of a segmentation neural network having a sub-network with an architecture that is specified by the candidate graph; and
selecting the brain emulation neural network architecture based on the performance measures.

17. The method of claim 16, wherein each of the plurality of candidate graphs is a respective sub-graph of the synaptic connectivity graph.

18. The method of claim 17, wherein selecting the brain emulation neural network architectures based on the performance measures comprises:
identifying a best-performing candidate graph that is associated with a highest performance measure from among the plurality of candidate graphs; and
selecting the brain emulation neural network architecture to be an artificial neural network architecture specified by the best-performing candidate graph.

19. A system comprising:
one or more computers; and
one or more storage devices communicatively coupled to the one or more computers, wherein the one or more storage devices store instructions that, when executed by the one or more computers, cause the one or more computers to perform operations comprising:
receiving a training dataset comprising a plurality of training examples, wherein each training example comprises: (i) an image, and (ii) a segmentation defining a target region of the image that has been classified as including pixels in a target category;
determining a respective refined segmentation for each training example, comprising, for each training example:
processing the target region of the image defined by the segmentation for the training example using a de-noising neural network to generate a network output that defines the refined segmentation for the training example,
wherein the de-noising neural network comprises a brain emulation sub-network having a brain emulation neural network architecture that is based on synaptic connectivity between biological neurons in a brain of a biological organism; and
training a segmentation machine learning model on the training examples of the training dataset, comprising, for each training example:
training the segmentation machine learning model to process the image included in the training example to generate a model output that matches the refined segmentation for the training example.

20. One or more non-transitory computer storage media storing instructions that when executed by one or more computers cause the one or more computers to perform operations comprising:
receiving a training dataset comprising a plurality of training examples, wherein each training example comprises: (i) an image, and (ii) a segmentation defining a target region of the image that has been classified as including pixels in a target category;
determining a respective refined segmentation for each training example, comprising, for each training example:
processing the target region of the image defined by the segmentation for the training example using a de-noising neural network to generate a network output that defines the refined segmentation for the training example,
wherein the de-noising neural network comprises a brain emulation sub-network having a brain emulation neural network architecture that is based on synaptic connectivity between biological neurons in a brain of a biological organism; and
training a segmentation machine learning model on the training examples of the training dataset, comprising, for each training example:
training the segmentation machine learning model to process the image included in the training example to generate a model output that matches the refined segmentation for the training example.
